(19) United States
(12) Patent Application Publication
(10) Pub. No.: US 2009/0029814 A1
(43) Pub. Date: Jan. 29, 2009

(54) CLAMPING OR GUIDING RAIL FOR A TRACTION MECHANISM, ESPECIALLY A CHAIN DRIVE

(75) Inventor: Bolko Schuseil, Adelsdorf (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/095,862

(22) PCT Filed: Nov. 28, 2006
(86) PCT No.: PCT/EP06/68967

§ 371 Date: Jun. 23, 2008

(30) Foreign Application Priority Data
Dec. 1, 2005 (DE) 10 2005 057 295.2

(51) Int. Cl. F16H 7/08

(52) U.S. Cl. 474/111

(57) ABSTRACT

A tensioning or guiding rail for a traction mechanism, especially a chain drive, is provided, and includes a carrier body and a slide path lining arranged on the carrier body. The carrier body (2) is a standardized component having at least one standardized attachment section (8) for the slide path linings (7, 7′, 7″), which differ in form, but nevertheless include at least one standardized attachment section (9) that corresponds to the attachment section (8) of the carrier body (2).

### BACKGROUND

The invention relates to a tensioning or guiding rail for a traction mechanism, in particular, a chain drive, comprising a carrier body and a slide path lining arranged on this carrier body.

Tensioning or guiding rails of the type in question are used for tensioning a traction mechanism, such as a belt or a chain, in order to maintain a certain minimum tension or to guide the traction mechanism. Typically, such a rail has a carrier body, which is made from metal or plastic. Mounted on this carrier body is a slide path lining, which involves a separate component, typically made from plastic, primarily polyamide. Like the carrier body, the slide path lining itself also has an elongated or rail-like construction.

Typically, a rail is designed separately for each specific purpose, i.e., a special carrier body, as well as also a special slide path lining, is designed for each application or is defined with geometry adapted to the conditions. This is necessarily associated with expensive tool construction, because a separate tool must be produced for each carrier body shape and each slide path lining form. This increases the actual costs of such rails, as well as also the bearing holder, because a plurality of different components must be kept in storage.

### SUMMARY

The invention is thus based on the objective of specifying a tensioning or guiding rail of the type named above, which, in contrast, is improved and which, in particular, can be manufactured economically.

For meeting this objective, for a tensioning or guiding rail of the type noted above, it is provided according to the invention that the carrier body is a standardized component with at least one standardized attachment section for slide path linings, which are different in form but which each have at least one standardized attachment section corresponding to the one or more attachment sections of the carrier body.

The invention is based on the idea of configuring the carrier body as a standardized component for a plurality of different rail configurations. The actual rail variation is here realized for the design according to the invention just by means of the slide path lining, which—because it is a separate component—can have a configuration that is specific to the use or application. According to the purpose, the slide path lining designed according to the purpose is set on the standardized carrier body.

Because only one standardized carrier body is used for different rail types, for which only one tool is to be designed, these rails can be consequently produced economically. Considerable improvements are also produced with respect to the bearing holder, because only one standardized carrier body must be produced.

To allow the arbitrary, basically modular-like ability to connect between standardized carrier bodies and individually designed slide path linings, standardized attachment sections or attachment possibilities are provided on the standardized carrier body, as well as also on each slide path lining. That is, these standardized attachment sections or attachment possibilities have identical configurations on all of the different slide path linings, even though the geometry of each slid path lining varies, for example, its length, its surface curvature, its thickness, etc.

The standardized attachment section of the carrier body is preferably the contact face for the slide path lining itself. The slide path lining is connected to the carrier body across the entire length of the contact face of the carrier body, so that a large surface-area contact is produced. That is, the slide path lining surface opposite the contact face of the carrier body corresponds in its length, width, and form exactly to the contact face on the carrier body.

For the attachment, a wide range of different possibilities is conceivable. First, the guiding rail can be encompassed or engaged behind by each slide path lining on at least one longitudinal end, advantageously on both longitudinal ends. That is, here an end-side locking or snap connection can be realized, thus, the slide path lining is snapped onto the carrier body. For this purpose, on the slide path linings, corresponding catch or snap hooks are constructed, which connect to the attachment section that is provided on the slide path lining and that corresponds to the contact face shape on the carrier body. In this configuration, the slide path lining contacts the entire surface of the contact surface and is locked at the end of the carrier body.

Alternatively or additionally, on the carrier body, in particular, along the contact face there are one or more snap-in or catch receptacles for snap-in or catch elements, in particular, pins or connecting pieces, provided on the slide path lining. For example, optionally in addition to the end-side locking or snap connections, along the contact face there are one or more openings or recesses, in which corresponding catch or snap-in elements, which protrude on the opposing face on the slide path bearing, engage in a tensioning or locking way.

Alternatively or additionally, it would also be conceivable to provide on the slide path lining one or more openings, in which attachment means, such as a screw or a rivet or the like, can be inserted, which engage in corresponding receptacles or openings in the carrier body. That is, in this configuration there is the possibility of screwing or riveting the slide path lining tightly onto the carrier body, optionally also for locking or snap attachment in the region of the longitudinal ends.

In another possible alternative or additional attachment variant, a slide path lining and the carrier body are bonded to each other. This is provided with respect to the surface-area contact of the slide path support along the contact face on the carrier body.

### BRIEF DESCRIPTION OF THE DRAWINGS

Additional advantages, features, and details of the invention emerge from the embodiments described in the following, as well as with reference to the drawings. Shown herein are:

FIG. 1 is a view of a tensioning or guiding rail according to the invention in a first embodiment,

FIG. 2 is a view of a tensioning or guiding rail according to the invention in a second embodiment, and

FIG. 3 is a view of a tensioning or guiding rail according to the invention in a third embodiment.

### DETAILED DESCRIPTION OF THE PREFERRED EMBODIMENTS

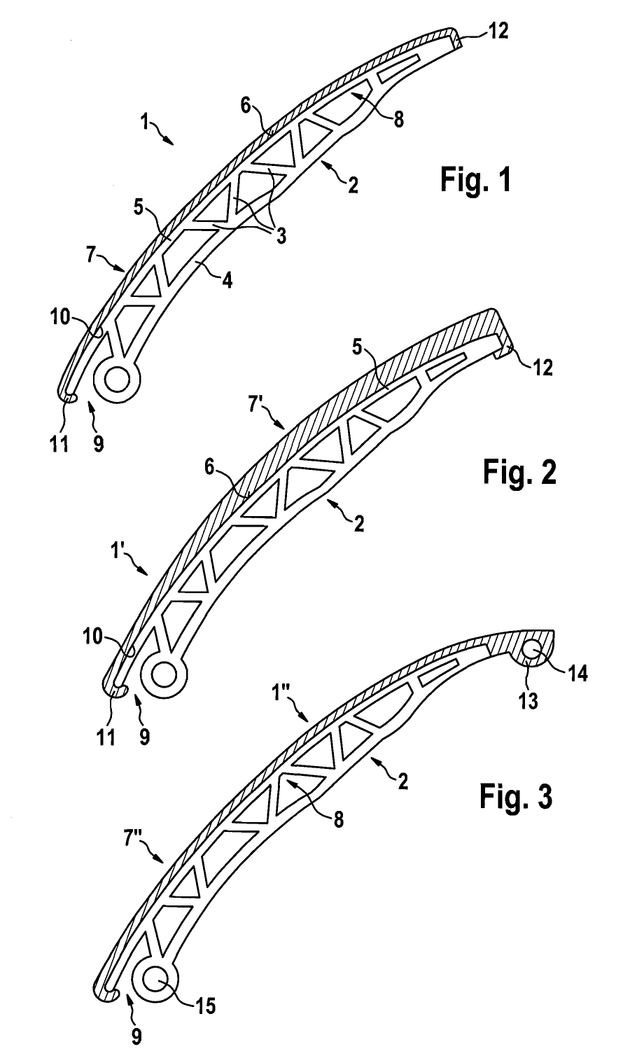

FIG. 1 shows a tensioning or guiding rail 1 according to the invention, comprising a standardized carrier body 2, which can be made from metal, for example, aluminum or a sheet metal or plastic. The standardized carrier body 2 has various reinforcing ribs 3, which run between a lower body section 4 and an upper body section 5 that is bent. The upper body section 5 forms, with its surface, a contact face 6 for a slide path lining 7. The contact face 6 is essentially rectangular—viewed in a top view—and extends in the illustrated example across the entire length of the carrier body 2. The contact face 6 or the upper body section 5 forms a standardized attachment section 8, on which the slide path lining 7 is held.

The slide path lining 7 likewise has a standardized attachment section 9. Its inner surface 10, that is, the surface opposite the contact face 6 on the upper body section 5, is shaped identical to the contact face 6, so that a complete surface contact is produced. In addition, the slide path lining 7 is lengthened at the ends, so that catch hooks or sections 11, 12 are formed that encompass the upper body section 5 at its longitudinal ends and consequently engage behind or lock there.

These standardized attachment sections 8, 9 on the carrier body 2 and the slide path lining 7 are repeated in all of the tensioning rails according to the invention. The carrier body itself has an overall standardized configuration, thus, it is identical overall—see the following constructions. Each slide path lining varies in its shape, but all have the identical attachment section 9, as shown in FIG. 1.

As an alternative to the embodiment according to FIG. 1, FIG. 2 shows a tensioning or guiding rail 1′ according to the invention. The carrier body 2 is there identical to the carrier body 2 from FIG. 1. The slide path lining 7′ is different in its shape than the slide path lining 7 from FIG. 1, but it has the identical attachment section 9 like the slide path lining 7 from FIG. 1. That is, here the inner surface 10 of the slide path lining 7′ is also configured in a way corresponding to the contact face 6 of the upper carrier body section 5. Furthermore, at the ends of the slide path lining 7′, here corresponding catch sections 11, 12 are also provided, which engage behind or around the upper carrier body section 5 on the longitudinal ends. As is visible here, however, the thickness of the slide path lining 7′ varies across its length in comparison with the dimensioning of the slide path lining 7 from FIG. 1.

Because each slide path lining involves a separate component, very different lining geometries can be realized, whether in terms of length (it could theoretically also extend past the carrier body length) or wall thickness or the realized guiding radius.

FIG. 3 shows another construction according to the invention of a tensioning or guiding rail 1″. The carrier body 2 corresponds to the standardized carrier bodies from FIGS. 1 and 2. The slide path lining 7″ here also has a standardized attachment section 9, as described for the preceding embodiments. Different than in the preceding configurations, the slide path lining 7″ on the right end, in comparison to that shown in FIG. 1, has a lengthened construction. It has a attachment section 13, in which a bearing opening or receptacle 14 is provided. An attachment bolt or an attachment screw, for example, can be inserted through this opening or receptacle, so that there is the possibility of fixing the slide path lining 7 on a third object, in addition to the carrier body 2, which—like in all of the other configurations—is mounted on this third object by a bearing opening or receptacle 15, through which a bolt or a screw is inserted.

As an alternative to the configurations shown in the figures, it would be conceivable to bond the slide path lining, for example, also to the carrier body, which is useful and possible, because the inner surface 10 of each slide path lining forms a total surface area contact on the contact face 6 of the carrier body 2. It would also be conceivable to place corresponding attachment elements, such as screws, in this region, consequently, to screw the slide path lining on the carrier body. Alternatively, it would also be conceivable to provide, along the upper carrier body section 5, one or more snap-in or catch openings, in which engage catch or snap-in pins or the like, which protrude on the inner surface 10 of each slide path lining.

As a whole, the “modular system” according to the invention allows the forming of very different tensioning or guiding rails, which all have, however, an identical, standardized carrier body. This is allowed because both on the carrier body and also on each slide path lining there are standardized attachment sections or attachment elements.

### REFERENCE NUMBERS

1 Tensioning or guiding rail
2 Carrier body
3 Reinforcing ribs
4 Lower body section
5 Upper body section
6 Contact face
7 Slide path lining
8 Attachment section
9 Attachment section
10 Inner surface
11 Catch hook
12 Catch hook

1. Tensioning or guiding rail for a traction mechanism comprising a carrier body and a slide path lining arranged on the carrier body, the carrier body is a standardized component with at least one standardized attachment section for receiving one of a plurality of the slide path linings, which differ in shape but which each have at least one standardized attachment section corresponding to the at least one standardized attachment section of the carrier body.

2. Tensioning or guiding rail according to claim 1, wherein the standardized attachment section of the carrier body comprises a contact face for the slide path lining.

3. Tensioning or guiding rail according to claim 1, wherein the carrier body is encompassed or engaged behind by an installed one of the slide path linings on at least one longitudinal end.

4. Tensioning or guiding rail according to claim 1, wherein on the carrier body along the contact face, there are one or more snap-in or catch receptacles for snap-in or catch elements provided on the slide path lining.

5. Tensioning or guiding rail according to claim 1, wherein one or more receptacles for attachment elements are provided on the carrier body along the contact face, and corresponding openings, through which the attachment elements are inserted, are provided on the slide path lining.

6. Tensioning or guiding rail according to claim 1, wherein that the slide path lining and the carrier body are bonded to each other.

7. Tensioning or guiding rail according to claim 1, wherein the carrier body is encompassed or engaged behind by an installed one of the slide path linings on both longitudinal ends.
